(19) United States
(12) Patent Application Publication
(10) Pub. No.: US 2026/0166745 A1
(43) Pub. Date: Jun. 18, 2026

(54) METHOD FOR DETERMINING A POSITION OF A ZONE OF A TOOL

(71) Applicant: INBOLT, Igny (FR)

(72) Inventor: Louis MUFFANG, Igny (FR)

(73) Assignee: INBOLT, Igny (FR)

(21) Appl. No.: 19/119,804

(22) PCT Filed: Oct. 13, 2023
(86) PCT No.: PCT/FR2023/051599

§ 371 Date: Apr. 10, 2025

(30) Foreign Application Priority Data
Oct. 13, 2022 (FR) FR2210547

(51) Int. Cl. B25J 9/16; B25J 13/08; B25J 19/02

(52) U.S. Cl. CPC B25J 9/1697; B25J 9/1692; B25J 13/089; B25J 19/023

(57) ABSTRACT

A method for determining a position of a zone of a tool relative to an image-capturing device located on the tool includes placing the zone of the tool at a fixed point for which the location relative to a calibration device is known, said calibration device comprising at least one visual marker; determining, by the image-capturing device, the position of the visual marker relative to the image-capturing device, and determining the position of the zone of the tool relative to the image-capturing device, based on the position of the visual marker relative to the image-capturing device and based on the location of the fixed point relative to the calibration device.

### TECHNICAL FIELD

The present disclosure relates to the field of methods for determining a position of a zone of a tool relative to an image-capturing device located on the tool, and associated devices.

### PRIOR ART

Determining the position of a zone of a tool within a defined frame of reference, which can also be referred to as “calibrating the zone of the tool”, is an essential element in ensuring the proper functioning of a system for determining the location of the zone of the tool.

In this regard, in the field of robotic arms, it is known to determine the position of a zone of a tool located on the robotic arm, most often the tip of the robotic arm, by repeatedly pointing the zone of the tool towards a known location. Alternatively, to determine the position of the tip of the robotic arm, it is common to make use of the intersection between laser beams from known positions and the tip of the robotic arm.

However, pre-existing solutions rely on knowledge concerning the kinematics of encoders in the links forming the robotic arm. These solutions are therefore not suitable for tools for which the tool kinematics are not known.

### SUMMARY

The present disclosure improves the situation.

A method is provided for determining a position of a zone of a tool relative to an image-capturing device located on the tool, the method comprising the steps of:
placing the zone of the tool at a fixed point for which the location relative to a calibration device is known, said calibration device comprising at least one visual marker,
determining, by means of the image-capturing device, the position of the visual marker relative to the image-capturing device,
determining the position of said zone of the tool relative to the image-capturing device, based on the position of the visual marker relative to the image-capturing device and based on the location of the fixed point relative to the calibration device.

Advantageously, the proposed method makes it possible to determine the position of the zone of the tool relative to the image-capturing device located on the tool, without requiring knowledge of the tool's kinematics. The proposed method is therefore suitable for all types of tools. In particular, the proposed method is suitable for tools mounted on robotic arms as well as for manual tools. It is notable that the proposed method proves to be less complex than prior art solutions which require mechanical pointing or a mechanical sight. The proposed method thus allows calibrating the zone of the tool within around two minutes, while prior art solutions sometimes reach times of around fifteen minutes to obtain a similar result.

Thus, by means of the proposed method, it is made possible to deduce the position of the zone of the tool when the position of the image-capturing device is known. As a result, tracking the position of the zone of the tool can be carried out based on information concerning the position of the image-capturing device. Also, according to one or more embodiments, operations performed by the zone of the tool, for example tightening or screwing, can be controlled.

The features set forth in the following paragraphs may optionally be implemented, independently of one another or in combination with one another.

According to one or more embodiments, the at least one visual marker is a 2D visual marker. Advantageously, determining the position of the at least one 2D visual marker relative to the image-capturing device may be done based on a 2D image captured by the image-capturing device. According to one or more embodiments, determining the position of the at least one 2D visual marker relative to the image-capturing device may further be done based on a 3D image and/or at least one 2D image capable of providing spatial positions and an intensity of the pixels of the visual marker.

Alternatively, according to one or more embodiments, the at least one visual marker is a three-dimensional (3D) visual marker. According to one or more embodiments, the at least one three-dimensional visual marker is non-symmetrical. Advantageously, asymmetry makes it possible to avoid positioning ambiguities. Thus, according to one or more embodiments, the at least one visual marker may be all or part of an asymmetrical object. In particular, according to one or more embodiments, the asymmetrical object may be obtained by 3D printing. Advantageously, determining the position of the at least one 3D visual marker relative to the image-capturing device may be done based on a 3D image captured by the image-capturing device. According to one or more embodiments, determining the position of the at least one 3D visual marker relative to the image-capturing device may further be done based on information originating from a computer-aided design (CAD) model of the 3D visual marker.

According to one or more embodiments, the calibration device may comprise a plurality of visual markers and the position of the image-capturing device may be determined relative to at least a portion of the plurality of visual markers.

Advantageously, determining the position of the image-capturing device relative to at least a portion of the plurality of visual markers makes it possible to increase the calibration accuracy of the zone of the tool. Indeed, the position of the image-capturing device may thus be obtained by making use of information from several visual markers, reducing uncertainty in the relative position between a frame of reference of the image-capturing device and a frame of reference of the calibration device.

According to one or more embodiments, the method may comprise determining a plurality of positions of the at least one visual marker relative to the image-capturing device, by means of the image-capturing device, and the steps of:
determining, for each of the positions of the plurality of determined positions of the at least one visual marker relative to the image-capturing device, a primary position of said zone of the tool relative to the image-capturing device, based on the position of the visual marker
relative to the image-capturing device and based on the location of the fixed point relative to the calibration device,
partitioning into groups the plurality of primary positions of said zone of the tool relative to the image-capturing device,
determining the size of a group containing the most primary positions,
determining, as a function of the determined size of the group, the position of said zone of the tool relative to the image-capturing device, based on the primary positions of the group of the determined size.

“Partitioning” is understood to mean partitioning the data, or “data clustering”. Partitioning aims to divide the plurality of primary positions into different groups of primary positions, while minimizing intra-class inertia within the groups and maximizing inter-class inertia between the groups.

Advantageously, the proposed method also makes it possible to increase the precision and accuracy in calibrating the zone of the tool by determining the position of the zone of the tool relative to the image-capturing device by making use of a plurality of primary positions. In particular, erroneous positions, for example determined from images captured while the zone of the tool was not placed on the fixed point, may thus be excluded from the calibration of the zone of the tool.

According to one or more embodiments, the plurality of positions of the at least one visual marker relative to the image-capturing device may comprise the positions which were determined based on a portion of the plurality of visual markers, said portion comprising a number of visual markers that is greater than a threshold.

Advantageously, the accuracy of the calibration of the zone of the tool may thus be modulated by varying the threshold value.

According to one or more embodiments, the step of determining the plurality of primary positions of the zone of the tool relative to the image-capturing device will be iterated until the size of the group containing the most primary positions is greater than a threshold value.

Advantageously, the accuracy of the calibration may be increased by varying the threshold value. An intermediate position of the zone of the tool outside the fixed point may thus be excluded from the determination of the position of the zone of the tool.

According to one or more embodiments, the calibration device will comprise, at the fixed point for which the location relative to the calibration device is known, at least a portion of a pivot connection or of a ball joint connection between the fixed point for which the location is known and the zone of the tool.

Advantageously, the presence of a portion of a pivot connection or of a ball joint connection at the fixed point adds at least one degree of freedom in the relative movements between the image-capturing device and the calibration device, while maintaining the position of the zone of the tool relative to the fixed point. Thus, a variety of positions between the image-capturing device and the calibration device can enrich the calibration data, making it possible to increase the precision and accuracy of the calibration. Additionally, the presence of at least a portion of a ball joint connection makes it possible to obtain substantially uniform data in a three-dimensional space. In particular, a height of the image-capturing device relative to the calibration device may be modified, enabling the image-capturing device to acquire images of visual markers that would not have been otherwise visible.

According to one or more embodiments, the method will further comprise the steps of:
rotating the zone of the tool about an axis of the zone of the tool, by means of the pivot connection,
determining, by means of the image-capturing device, a plurality of positions of the image-capturing device relative to the at least one visual marker of the calibration device, as a function of the rotation about the axis of the zone of the tool,
determining an axis of the zone of the tool relative to the image-capturing device, based on the plurality of positions of the image-capturing device relative to the visual marker as a function of the rotation about the axis of the zone of the tool.

“Axis of the zone of the tool” is understood here to mean an axis along which an accessory attached to the zone of the tool may extend. One end of an accessory attached to the zone of the tool may thus be located on the axis of the zone of the tool. The position of the end of the accessory fixed to the zone of the tool on the axis of the zone of the tool may vary according to a size of the accessory.

Advantageously, knowledge of the axis of the zone of the tool thus makes it possible to constrain the space of allowable positions of the zone of the tool, or of one end of an accessory attached to the zone of the tool, relative to the image-capturing device.

Alternatively, according to one or more embodiments, determining the axis of the zone of the tool may comprise the steps of:
adding an accessory in the zone of the tool,
placing a zone of the accessory on the fixed point for which the location is known,
determining, by means of the image-capturing device, the position of the visual marker relative to the image-capturing device,
determining the position of said zone of the accessory relative to the image-capturing device, based on the position of the visual marker relative to the image-capturing device and based on the location of the fixed point relative to the calibration device,
determining an axis of the zone of the tool relative to the image-capturing device, based on the position of said zone of the tool relative to the image-capturing device and based on the position of said zone of the accessory relative to the image-capturing device.

According to one or more embodiments, in order to detect a change of a second accessory attached to the zone of the tool, the method will further comprise the steps of:
determining, by means of the image-capturing device, the position of one end of the second accessory relative to the image-capturing device, based on the axis of the zone of the tool.

Advantageously, automatic detection of a change of a second accessory attached to the zone of the tool may thus be achieved. Consequently, calibration of the end of the second accessory relative to the image-capturing device may be achieved without requiring that all the steps of the proposed method be reproduced. Calibration of the zone of the tool may thus be generalized for all types of accessories attached to the zone of the tool.

According to another aspect, an image-capturing device is provided for the implementation of a method according to the present description.

According to another aspect, a device is provided for calibrating a position of a zone of a tool relative to an image-capturing device located on the tool, the device comprising:
a fixed point for which the location relative to the device is known,
at least one visual marker for which the location relative to the device is known,
optionally, at least a portion of a pivot connection or of a ball joint connection located at the fixed point for receiving the zone of the tool.

According to another aspect, a computer program is provided comprising instructions for implementing all or part of a method as defined herein when the program is executed by a processor. According to another aspect, a non-transitory computer-readable storage medium is provided on which such a program is stored.

### BRIEF DESCRIPTION OF DRAWINGS

Other features, details and advantages will become apparent from reading the detailed description below, and from analyzing the attached drawings, in which:

FIG. 1 shows a robotic arm comprising a tool equipped with an image-capturing device according to one or more embodiments.

FIG. 2 shows a manual tool equipped with an image-capturing device according to one or more embodiments.

FIG. 3 shows a flowchart illustrating an exemplary implementation of the method according to one or more embodiments.

FIG. 4 shows a flowchart illustrating an exemplary implementation of the method according to one or more embodiments.

FIG. 5 shows a diagram of a tool equipped with an image-capturing device according to one or more embodiments.

FIG. 6 shows a flowchart illustrating an exemplary implementation of the method according to one or more embodiments.

FIG. 7 shows a top view of a calibration device according to one or more embodiments.

FIG. 8 shows a calibration device as well as a tool equipped with an image-capturing device according to one or more embodiments.

### DESCRIPTION OF EMBODIMENTS

In the following detailed description of embodiments of the invention, numerous specific details are presented to provide a more complete understanding. However, those skilled in the art can appreciate that embodiments may be implemented without these specific details. In other cases, well-known features are not described, to avoid unnecessarily complicating the description.

This description refers to illustrations of flowcharts and diagrams of the methods and devices according to one or more embodiments. Each of the flowcharts described may be implemented by hardware, software (including embedded software (firmware), or middleware), microcode, or any combination thereof. In the case of a software implementation, the flowchart illustrations may be implemented by computer program instructions or software code, which may be stored or transmitted on a computer-readable medium, including a non-transitory medium, or a medium loaded into the memory of a generic or specific computer, or any other programmable data processing apparatus or device for processing data to create a machine, such that the computer program instructions or software code executed on the computer or programmable data processing apparatus or device constitute means for implementing these functions.

Embodiments of a computer-readable medium include, but are not limited to, computer storage media and communication media, including any medium that facilitates the transfer of a computer program from one location to another. “Computer storage medium/media” means any physical medium that can be accessed by a computer. Examples of computer storage media include, but are not limited to, flash memory components or disks or any other flash memory devices (e.g., USB keys, memory keys, memory sticks, key disks), CD-ROMs or other optical data storage devices, DVDs, magnetic disk data storage devices or other magnetic data storage devices, data memory components, RAM, ROM, EEPROM, smart cards, SSD (“Solid State Drive”) memories, and any other form of media usable for transporting or storing or saving data or data structures that can be read by a computer processor.

In addition, various forms of computer-readable media may transmit or carry instructions to a computer, such as a router, gateway, server, or any data transmission device, whether wired (via coaxial cable, fiber optics, telephone wires, DSL cable, or Ethernet cable), wireless (via infrared, radio, cellular, microwave), or virtualized transmission devices (virtual router, virtual gateway, virtual tunnel endpoint, virtual firewall). The instructions may, depending on the embodiments, include code of any computer programming language or computer program element, such as, without limitation, assembly languages, C, C++, Visual Basic, HyperText Markup Language (HTML), Extensible Markup Language (XML), HyperText Transfer Protocol (HTTP), Hypertext Preprocessor (PHP), SQL, MySQL, Java, JavaScript, JavaScript Object Notation (JSON), Python, and bash scripting.

Furthermore, the terms “notably”, “for example”, and “exemplary” are used in the present description to designate examples or illustrations of non-limiting embodiments which do not necessarily correspond to embodiments which are preferred or advantageous with respect to other possible embodiments or aspects.

The terms “located”, “mounted”, “equipped with” and their various variants and forms used in the present description refer to couplings, connections, assemblies which may be direct or indirect. Thus, an image-capturing device located/mounted on a tool may be directly located on the tool or on an intermediate element positioned between the image-capturing device and the tool.

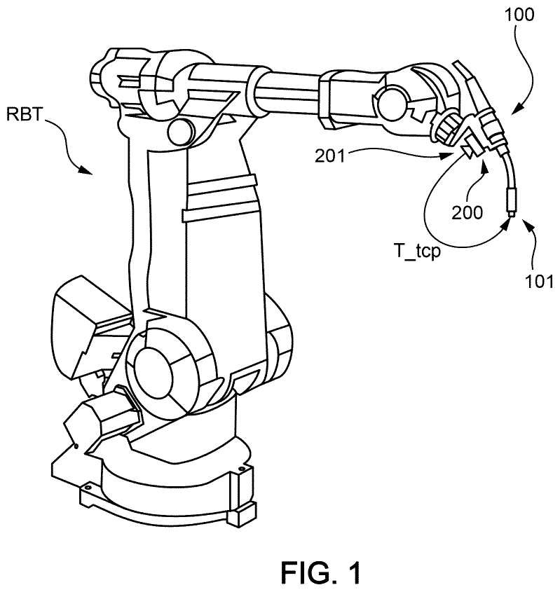

FIG. 1 shows, as a non-limiting example of a tool 100, a tightening or screwing tool mounted on a robotic arm RBT according to one or more embodiments. Alternatively, tool 100 may be a machining tool, for example one among a drilling tool, a deburring tool, a chamfering tool, a polishing tool, or any other tool suitable for implementing the proposed method such as a welding tool. In the example of FIG. 1, zone 101 of the tool to be calibrated corresponds to the head of tool 100, meaning the point of tool 100 where the action to be performed takes place. Thus, in the case of the tightening tool shown in FIG. 1, the head of tool 100 may correspond to an end of a socket. In the case of a drilling tool, the head of the tool may notably correspond to one end of a drill bit.

Furthermore, tool 100 is provided with an image-capturing device 200. Image-capturing device 200 is configured to acquire images. Image-capturing device 200 comprises, for example, a two-dimensional (2D) camera or a three-dimensional (3D) camera. According to one or more embodiments, image-capturing device 200 comprises a 2D camera and a 3D camera, making it possible to take advantage of the information obtained by the two cameras. According to one or more embodiments, the 2D camera comprises two three-color lenses (red, green, blue, RGB), coupled to an inertial measurement unit. According to one or more embodiments, the 3D camera is an Active Stereo type camera. Furthermore, image-capturing device 200 is operatively coupled to a processor enabling the implementation of the methods described in the present description.

As shown in FIG. 1, zone 101 of the tool may be apart from image-capturing device 200. More particularly, an offset, denoted T_tcp, between center 201 of image-capturing device 200 and zone 101 of the tool is observable in FIG. 1.

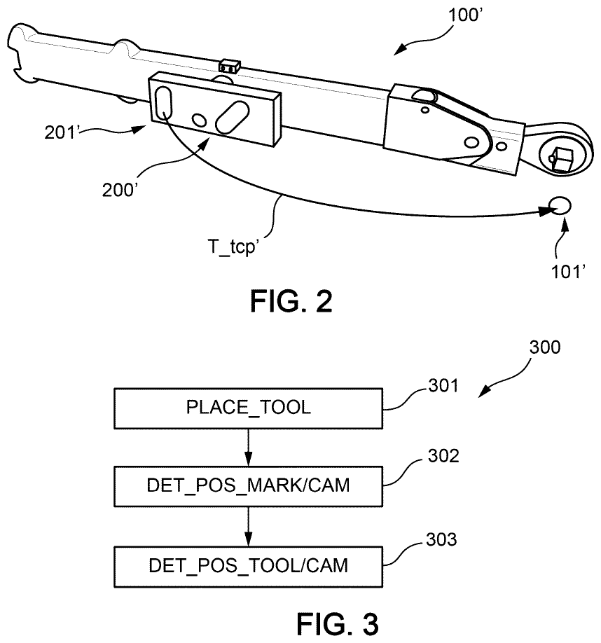

Alternatively, FIG. 2 shows, as a non-limiting example of a tool 100′, a portable manual tool. More particularly, the example in FIG. 2 represents a manual tightening tool, more specifically a ratchet. Alternatively, tool 100′ may be a manual tool among a manual screwing tool, a manual drilling tool, a manual deburring tool, a manual chamfering tool, a manual polishing tool, a manual welding tool, or any other manual tool suitable for implementing the proposed method.

As with tool 100 of FIG. 1, an image-capturing device 200′ is located on tool 100′. The offset between center 201′ of image-capturing device 200′ and zone of interest 101′ of the tool is denoted T_tcp′. The zone of interest of the tool is for example the end of a socket in the case of a ratchet.

In each of the cases set forth above, knowledge of offset T_tcp, T_tcp′ is sought in order to deduce, from an image acquired by the image-capturing device, the position of zone of interest 101, 101′ relative to image-capturing device 200.

To this end, FIG. 3 is a flowchart illustrating the proposed method 300 for calibrating the zone of the tool according to one or more embodiments.

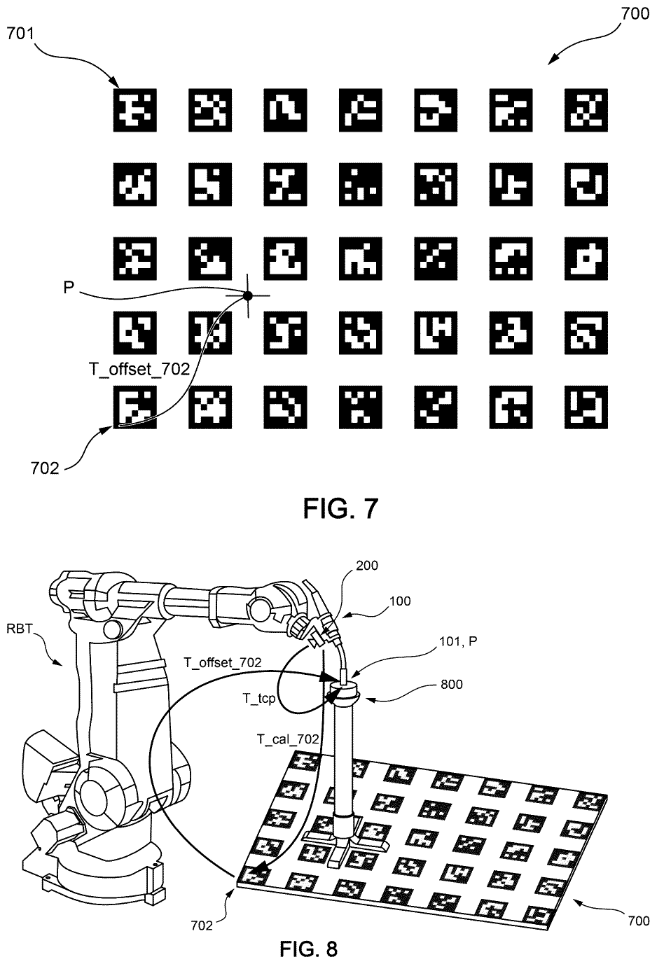

In a first step PLACE_TOOL 301, zone of interest 101, 101′ of the tool is placed at a fixed point. The fixed point is a point for which the location relative to a calibration device is known. Thus, the coordinates, respectively denoted T_offset, T_offset′ in FIGS. 6 and 7, of the fixed point in a frame of reference of the calibration device are known.

Furthermore, the calibration device comprises at least one visual marker. A location of the visual marker relative to the calibration device is known. Therefore, the location of the fixed point relative to the at least one visual marker is also known. As shown in FIGS. 7 and 8 for example, and as discussed below, according to one or more embodiments, the at least one visual marker is a two-dimensional (2D) visual marker.

In a second step DET_POS_MARK/CAM 302, the position of the visual marker relative to image-capturing device 200, 200′ is determined by means of image-capturing device 200, 200′.

According to one or more embodiments, the determination 302 of the position of the visual marker relative to image-capturing device 200, 200′ comprises, in a first sub-step, the detection of the at least one visual marker by image-capturing device 200, 200′. In particular, the detection of the at least one visual marker by image-capturing device 200, 200′ may be done based on a 2D image captured by image-capturing device 200, 200′. The 2D image may be a grayscale image. Alternatively, the 2D image may be a color image. According to one or more embodiments, the detection of the at least one visual marker by image-capturing device 200, 200′ based on the 2D image is performed by means of a computer vision library, for example the OpenCV library. According to one or more embodiments, the ArUco library may be used (S. Garrido-Jurado, R. Muñoz-Salinas, F. J. Madrid-Cuevas, and M. J. Marín-Jiménez. 2014. “Automatic generation and detection of highly reliable fiducial markers under occlusion”. Pattern Recogn. 47, 6 (June 2014), 2280-2292. DOI=10.1016/j.patcog.2014.01.005).

According to one or more embodiments, in a second sub-step, a 3D position of the at least one visual marker relative to image-capturing device 200, 200′ is determined. According to one or more embodiments, the 3D position of the at least one visual marker relative to image-capturing device 200, 200′ is obtained based on the 2D image. More particularly, according to one or more embodiments, the 3D position of the at least one visual marker relative to image-capturing device 200, 200′ is obtained by means of a computer vision library which takes the 2D image as input. According to one or more embodiments, the computer vision library may also take one or more parameters intrinsic to image-capturing device 200, 200′ as input. For example, the computer vision library is the OpenCV library. More particularly, the ArUco library may be used. Alternatively, according to one or more embodiments, when image-capturing device 200, 200′ comprises a 3D camera, the 3D position of the at least one visual marker relative to image-capturing device 200, 200′ may be directly acquired by the 3D camera.

According to one or more embodiments, in a third sub-step, a 3D transformation between the coordinate system of the frame of reference of image-capturing device 200, 200 and the coordinate system of the frame of reference of the calibration device is determined. According to one or more embodiments, the 3D transformation between the coordinate system of the frame of reference of image-capturing device 200, 200 and the coordinate system of the frame of reference of the calibration device is determined based on the 3D position of the at least one visual marker relative to image-capturing device 200, 200′ and on a 3D position of the at least one visual marker relative to the calibration device. According to one or more embodiments, the 3D position of the at least one visual marker relative to the calibration device is known in principle and recorded. According to one or more embodiments, the 3D transformation between the coordinate system of the frame of reference of image-capturing device 200, 200 and the coordinate system of the frame of reference of the calibration device is represented by a matrix, denoted M_{T_CAL}, of size 3×3, such that the 3D position of the at least one visual marker relative to image-capturing device 200, 200′ and the 3D position of the at least one visual marker relative to the calibration device, respectively denoted X_{CAM} and X_{MARK}, can be expressed by the relation [Math. 1] below:

$${X}_{CAM} = {M}_{T\_CAL} * {X}_{MARK} \qquad [ Math . 1 ]$$

Consequently, the 3D transformation between the coordinate system of the calibration frame of reference and the frame of reference of image-capturing device 200, 200 is also known. Indeed, a matrix of the 3D transformation between the coordinate system of the calibration frame of reference and the frame of reference of image-capturing device 200, 200 can be expressed as the inverse of matrix M_{T_CAL}.

In a third step DET_POS_TOOL/CAM 303, the position of the zone of interest of tool 101, 101′ relative to image-capturing device 200, 200′, respectively denoted T_tcp, T_Top′ in FIGS. 6 and 7, is determined. Position T_tcp, T_Tcp′ of zone 101, 101′ of the tool relative to image-capturing device 200, 200′ is obtained based on the position of the visual marker relative to image-capturing device 200, 200′ and based on location T_offset, T_offset′ of the fixed point relative to the calibration device. According to one or more embodiments, position T_tcp, T_Tcp′ of zone 101, 101′ of the tool, relative to image-capturing device 200, 200′, is obtained according to the respective relations [Math. 2], [Math. 2′], below:

$$T\_tcp = {M}_{T\_CAL} * T\_offset \qquad [ Math . 2 ]$$

$${T\_tcp}^{′} = {M}_{T\_CAL} * {T\_offset}^{′} \qquad [ Math . {2}^{′} ]$$

Method 300 described above with reference to FIG. 3 may be iterated. According to one or more embodiments, image-capturing device 200, 200′ acquires a plurality of images. Acquisition of the plurality of images may be carried out at regular time intervals. For example, an acquisition frequency may be between 10 Hz and 100 Hz, more preferably between 10 Hz and 2 Hz, even more preferably about 15 Hz.

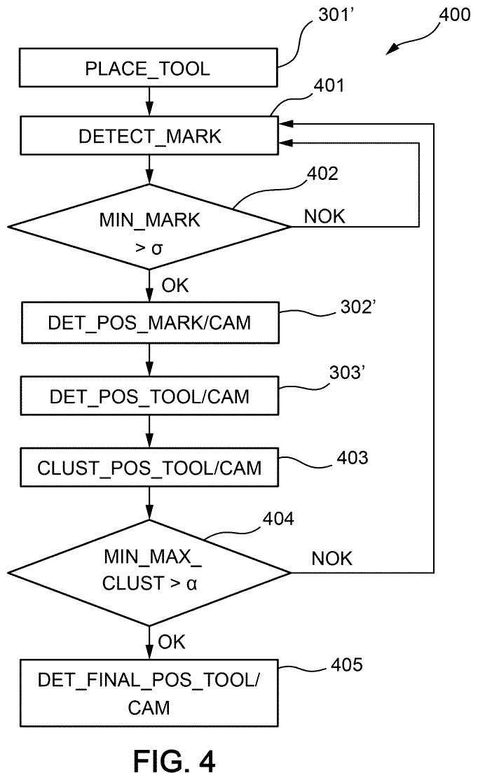

According to one or more embodiments, in cases where a plurality of positions of the at least one visual marker relative to image-capturing device 200, 200′ is acquired, the calibration method 400 illustrated in FIG. 4 may be implemented.

According to one or more embodiments, in a first step PLACE_TOOL 301′, zone of interest 101, 101′ of the tool is placed at a fixed point similarly to step PLACE_TOOL 301 described with reference to FIG. 3.

For one or more of the images of the plurality of acquired images, or even for each image of the plurality of acquired images, a detection of the at least one visual marker that is similar to the detection of the at least one visual marker described with reference to FIG. 3 may be implemented.

According to one or more embodiments, in cases where the calibration device comprises a plurality of visual markers, method 400 may comprise an optional second step DETECT_MARK 401. Step DETECT_MARK 401 may comprise, for one or more of the images in the plurality of acquired images, or even for each image in the plurality of acquired images, a determination of a number of visual markers detected in the image.

According to one or more embodiments, in cases where optional step DETECT_MARK 401 is implemented, the method may comprise a third step MIN_MARK 402 that is also optional. Step MIN_MARK 402 may comprise, for one or more of the images in the plurality of acquired images, or even for each image in the plurality of acquired images, a comparison of the number of visual markers determined in step DETECT_MARK 401 with a first threshold value σ. First threshold value σ may advantageously be chosen to be between 1 and 20, preferably between 2 and 15, more preferably about 4. According to one or more embodiments, if, for an image, the number of visual markers determined in step DETECT_MARK 401 is greater than first threshold value σ, as represented by the OK arrow exiting diamond 402 in FIG. 4, step 302′ may be implemented. Alternatively, if, for an image, the number of visual markers determined in step DETECT_MARK 401 is less than first threshold value σ, as represented by the NOK arrow exiting diamond 402 in FIG. 4, step 401 may be implemented on another image of the plurality of acquired images.

According to one or more embodiments, for one or more of the images of the plurality of acquired images, or even for each image of the plurality of acquired images, the determination 302′ of the position of the at least one visual marker by image-capturing device 200, 200′ may be carried out according to one or more embodiments described above in connection with FIG. 3 for the determination 302 of the position of the at least one visual marker by image-capturing device 200, 200′, for which the description is not repeated here for the purposes of conciseness in the present description. In particular, according to one or more embodiments, the determination 302′ of the position of the at least one visual marker by image-capturing device 200, 200′ is carried out only for the images for which the number of visual markers determined in step DETECT_MARK 401 is greater than first threshold value σ as indicated above.

According to one or more embodiments, for one or more of the images of the plurality of acquired images, or even for each image of the plurality of acquired images, the determination 303′ of the position of the zone of interest of tool 101, 101′ relative to image-capturing device 200, 200′ may be carried out according to one or more embodiments described above in connection with FIG. 3 for the determination 303 of the position of the zone of interest of tool 101, 101′ relative to image-capturing device 200, 200′, for which the description is not repeated here for the purposes of conciseness in the present description.

According to one or more embodiments, in a step CLUST_POS_TOOL/CAM 403, the positions of the zone of interest of tool 101, 101′ relative to image-capturing device 200, 200′ which were determined in step 303 may be partitioned into groups (“clustering”). According to one or more embodiments, a k-nearest neighbors (k-NN) algorithm may be used. According to one or more embodiments, the k-nearest neighbors (k-NN) algorithm may be used with two classes. Alternatively, according to one or more embodiments, a mean shift algorithm may be used. According to one or more embodiments, the partitioning may be achieved by means of a library intended for machine learning, for example the Scikit-Learn library (Pedregosa et al. 2011. “Scikit-learn: Machine Learning in Python,” JMLR 12, pp. 2825-2830). In particular, according to one or more embodiments, the DBSCAN algorithm may be used. According to one or more embodiments, a maximum distance between two points enabling them to be considered as in the same group may be adjusted. The maximum distance between two points enabling them to be considered as in the same group may advantageously be chosen to be between 1 mm and 3 mm, preferably between 1.5 mm and 2.5 mm, more preferably around 2 mm.

According to one or more embodiments, an optional step MIN_MAX_CLUST 404 may be implemented. Step MIN_MAX_CLUST 404 may comprise determining a size of a group among the groups determined in step CLUST_POS_TOOL/CAM 403. More particularly, the size of the group containing the most positions of the zone of interest of tool 101, 101′ relative to image-capturing device 200, 200′ may be determined. The determined size of the group may be compared to a second threshold value a. Second threshold value a may advantageously be chosen to be between 50 and 250, preferably between 100 and 200, more preferably around 150. According to one or more embodiments, if the determined size of the group is greater than second threshold value a, as represented by the OK arrow exiting diamond 404 in FIG. 4, step 405 may be implemented. Alternatively, if the determined group size is less than second threshold value a, as represented by the NOK arrow exiting diamond 404 in FIG. 4, step 401 may be implemented on an image, among the plurality of acquired images, for which none of steps 401, 402, 302′, 303′ and 403 have been implemented.

According to one or more embodiments, in a step DET_FINAL_POS_TOOL/CAM 405, a so-called “final” position of the zone of tool 101, 101′, 101″ is determined based on the positions of the group of the determined size. In particular, according to one or more embodiments, the “final” position of the zone of tool 101, 101′, 101″ is an average of the positions of the group of the determined size. Alternatively, the “final” position of the zone of tool 101, 101′, 101″ may be a median of the positions of the group of the determined size.

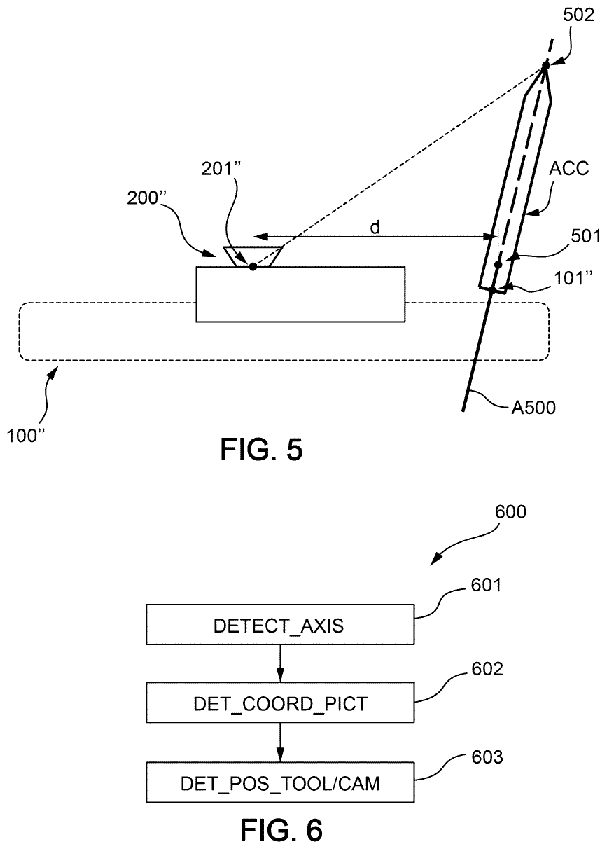

As is schematically illustrated in FIG. 5, according to one or more embodiments, an accessory, denoted ACC, may be attached to the zone of tool 101″.

According to one or more embodiments, a position of an end, denoted 502, of accessory ACC may be determined according to one of the methods set forth with reference to FIGS. 3 and 4.

Alternatively, according to one or more embodiments, a 3D position of end 502 of accessory ACC relative to image-capturing device 200″ may be deduced, by means of image-capturing device 200″, based on knowledge of an axis of the zone of the tool, denoted A500.

More particularly, a 2D position of end 502 relative to image-capturing device 200″ may be obtained in a 2D image captured by image-capturing device 200″ and comprising end 502. A 3D position of end 502 relative to image-capturing device 200″ may be obtained based on the 2D position and based on the knowledge of axis A500 of the zone of the tool.

For example, according to one or more embodiments, based on the knowledge of the axis of the zone of tool A500, a distance may be obtained, denoted d, between a center, denoted 201″, of image-capturing device 200″ and a point, denoted 501, that is coplanar with a plane of a lens of image-capturing device 200″, said plane passing through center 201″. Distance d can be designated by the term baseline.

Point 501 may define the center of a virtual image-capturing device directed along axis A500 of the tool. A 2D position of end 502 relative to the virtual image-capturing device may then be deduced. In particular, end 502 may be located at the center of a virtual image that would be captured by the virtual image-capturing device.

Thus, based on distance d between center 201″ of image-capturing device 200″ and center 501 of the virtual image-capturing device, and based on the positions of end 502 relative to image-capturing device 200″ and to the virtual image-capturing device, the 3D position of end 502 relative to image-capturing device 200″ may be obtained by triangulation. In particular, a distance, designated by the term disparity, denoted δ, may be determined between the position of end 502 relative to image-capturing device 200″ and the position of end 502 relative to the virtual image-capturing device. According to one or more embodiments, disparity δ may be measured in pixels between the position of end 502 relative to image-capturing device 200″ and the position of end 502 relative to the virtual image-capturing device. A third coordinate, or depth, denoted z, may be calculated from disparity δ and a focal length, denoted f, of image-capturing device 200″. Depth z may notably be calculated according to the formula [Math. 3] below:

$$z = ( d * f ) / δ \qquad [ Math . 3 ]$$

Alternatively, according to one or more embodiments, when image-capturing device 200″ comprises a 3D camera, the 3D position of end 502 relative to image-capturing device 200″ may be obtained directly from a 3D image captured by image-capturing device 200″ and comprising end 502.

Thus, FIG. 6 is a flowchart illustrating a method 600 for detecting an end of an accessory attached to the zone of tool 101″, the position of the zone of tool 101″ having been determined by one of the methods presented above.

In a first step DETECT_AXIS 601, axis A500 of the zone of tool 101″ is determined.

According to one or more embodiments, when the position of the zone of tool 101″ relative to image-capturing device 200″ is known, for example determined by one of the methods presented above, and when a position of the end of an accessory fixed to the zone of tool 101″ relative to image-capturing device 200″ is also known, for example determined by one of the methods presented above, axis A500 of the zone of tool 101″ may be determined as a single axis passing through these two positions.

Alternatively, according to one or more embodiments, the calibration device comprises, at fixed point P for which the location relative to the calibration device is known, a pivot connection between fixed point P for which the location is known and the zone of the tool. According to one or more embodiments, axis A500 of the zone of tool 101″ is determined by performing a rotation about axis A500 of the zone of tool 101″ by means of the pivot connection. More particularly, a plurality of positions of image-capturing device 200″ relative to the at least one visual marker of the calibration device may be acquired as a function of the rotation about axis A500 of the zone of the tool. An equation of axis A500 of the zone of the tool relative to image-capturing device 200″ may then be determined from the plurality of positions of image-capturing device 200″ relative to the at least one visual marker. Indeed, the plurality of positions of image-capturing device 200″ relative to the at least one visual marker forms an arc of a circle in a plane orthogonal to axis A500. A direction of axis A500 may thus be deduced from knowing the plane orthogonal to axis A500. The direction of axis A500 is normal to the plane orthogonal to axis A500. Thus, by knowing a point on axis A500, which is located at fixed point P for which the location is known, and a direction of axis A500, axis A500 can be uniquely determined.

In a second step DET_COORD_PICT 602, the 2D position of end 502 relative to image-capturing device 200″ is obtained in a 2D image captured by image-capturing device 200″ and comprising end 502.

According to one or more embodiments, the 2D position of end 502 relative to image-capturing device 200″ is obtained by means of a deep learning algorithm. For example, a convolutional neural network (CNN) may be used. A regional convolutional neural network (R-CNN) may notably be used. In particular, a mask regional convolutional neural network (Mask R-CNN) may be used. The deep learning algorithm may be trained with training images in order to detect end 502. The training images may comprise real images and/or simulated images. Data augmentation may be performed from an initial set of training images in order to obtain an augmented set of training images.

Alternatively, according to one or more embodiments, the 2D position of end 502 relative to image-capturing device 200″ is obtained by analyzing the light intensity of pixels along axis A500, in order to detect end 502. For example, edge detection may be used to extract end 502. In particular, a Canny edge detector may be used to extract end 502.

Alternatively, according to one or more embodiments, the 2D position of end 502 relative to image-capturing device 200″ is obtained by analyzing a plurality of images captured by image-capturing device 200″. Indeed, since end 502 is fixed relative to image-capturing device 200″, the position of end 502 relative to image-capturing device 200″ may be obtained by determining a position of a fixed point in the plurality of images. In particular, according to one or more embodiments, the plurality of images comes from a video stream captured by image-capturing device 200″.

In a third step DET_POS_TOOL/CAM 603, the 2D position of end 502 relative to image-capturing device 200″ is converted into the 3D position of end 502 relative to image-capturing device 200″, by exploiting the knowledge of axis A500 of the zone of the tool as explained with reference to FIG. 5.

FIG. 7 shows, as a non-limiting example of a calibration device 700, a top view of a calibration board. Alternatively, according to one or more embodiments (not shown), the calibration device is a non-planar 3D object.

Calibration device 700 comprises a fixed point P for which the location relative to the calibration device is known.

The represented calibration device 700 comprises a plurality of visual markers, including the visual markers denoted 701 and 702, for which the locations relative to device 700 are known. As shown in FIG. 7, fixed point P has a location T_offset_702 relative to a corner of visual marker 702. For clarity, the location of fixed point P in the frame of reference of each of the visual markers is not shown in FIG. 7. The visual markers shown in FIG. 8 are corners of markers from the OpenCV ArUco library. According to one or more embodiments (not shown), the visual markers may be corners of April Tags markers which can be found at the following address: https://april.eecs.umich.edu/software/apriltag. Alternatively, according to one or more embodiments (not shown), calibration device 700 comprises a single visual marker for which the location relative to calibration device 700 is known.

Optionally, according to one or more embodiments, calibration device 700 comprises a portion of a pivot connection or of a ball joint connection located at fixed point P, for receiving the zone of tool 101, 101′, 101″.

As can be seen in FIG. 8, the portion of ball joint connection 800 located at fixed point P may be a hollow half-sphere. The zone of tool 101 may be provided with a spherical tip configured to fit into the half-sphere during calibration. In this configuration, the zone of tool 101 may thus be coincident with fixed point P. Alternatively, according to one or more embodiments (not shown), the portion of the pivot connection located at fixed point P may comprise two nested cylinders.

As described above, the zone of tool 101 is placed, for example manually by an operator, on fixed point P for which the location relative to calibration device 700 is known. Position T_cal_702 of visual marker 702 relative to image-capturing device 200, which is a corner of a marker, is determined by means of image-capturing device 200. Robot RBT may generate movements of the zone of tool 101 over fixed point P by means of connection 800. During these movements, the acquired visual markers may vary without adversely impacting the implementation of the proposed method. Position T_top of the zone of tool 101 relative to image-capturing device 200 may then be determined from position T_cal_702 of visual marker 702 relative to image-capturing device 200 and from location T_offset_702 of fixed point P relative to visual marker 702.

Depending on the embodiment chosen, certain acts, actions, events, or functions of each of the methods described in this document may be performed or may occur in a different order than that in which they were described, or may be added, merged, or may not be performed or may not occur, as the case may be. Furthermore, in certain embodiments, certain acts, actions, or events are performed or occur concurrently and not successively.

In particular, according to one or more embodiments, the tool may be provided with a plurality of image-capturing devices. The number n of image-capturing devices in the plurality of image-capturing devices may advantageously be chosen to be between 2 and 4 inclusive. The calibration method described above may then be implemented for the n image-capturing devices. Advantageously, according to one or more embodiments, the calibration method described above may be implemented n times in parallel, using the same calibration device.

Although described through a certain number of detailed exemplary embodiments, the proposed calibration method and the device for implementing an embodiment of the method comprise different variants, modifications, and improvements which will be obvious to those skilled in the art, it being understood that these different variants, modifications, and improvements are within the scope of the present disclosure, as defined by the following claims. In addition, various aspects and features described above may be implemented together, or separately, or may be substituted for each other, and all of the various combinations and sub-combinations of the aspects and features are within the scope of the present disclosure. Furthermore, some systems and devices described above may not incorporate all of the modules and functions described for the preferred embodiments.

1-11. (canceled)

12. A method for determining a position of a zone of a tool relative to an image-capturing device located on the tool, the method comprising:
placing the zone of the tool at a fixed point for which the location relative to a calibration device is known, said calibration device comprising at least one visual marker,
determining, by the image-capturing device, the position of the visual marker relative to the image-capturing device,
determining the position of said zone of the tool relative to the image-capturing device, based on the position of the visual marker relative to the image-capturing device and based on the location of the fixed point relative to the calibration device.

13. The method according to claim 12, wherein the calibration device comprises a plurality of visual markers and wherein the position of the image-capturing device is determined relative to at least a portion of the plurality of visual markers.

14. The method according to claim 13, wherein a plurality of positions of the at least one visual marker relative to the image-capturing device is determined by the image-capturing device, the method further comprising the steps of:
determining, for each of the positions of the plurality of determined positions of the at least one visual marker relative to the image-capturing device, a primary position of said zone of the tool relative to the image-capturing device, based on the position of the visual marker relative to the image-capturing device and based on the location of the fixed point relative to the calibration device,
partitioning into groups the plurality of primary positions of said zone of the tool relative to the image-capturing device,
determining the size of a group containing the most primary positions,
determining, as a function of the determined size of the group, the position of said zone of the tool relative to the image-capturing device, based on the primary positions of the group of the determined size.

15. The method according to claim 14, wherein the plurality of positions of the at least one visual marker relative to the image-capturing device comprises the positions which were determined based on a portion of the plurality of visual markers, said portion comprising a number of visual markers that is greater than a threshold.

16. The method according to claim 15, wherein the step of determining the plurality of primary positions of said zone of the tool relative to the image-capturing device is iterated until the size of the group containing the most primary positions is greater than a threshold value.

17. The method according to claim 12, wherein the calibration device comprises, at the fixed point for which the location relative to the calibration device is known, at least a portion of a pivot connection or of a ball joint connection between the fixed point for which the location is known and the zone of the tool.

18. The method according to claim 17, further comprising:
rotating the zone of the tool about an axis of the zone of the tool, by the pivot connection,
determining, by the image-capturing device, a plurality of positions of the image-capturing device relative to the at least one visual marker of the calibration device, as a function of the rotation about the axis of the zone of the tool,
determining an axis of the zone of the tool relative to the image-capturing device, based on the plurality of positions of the image-capturing device relative to the visual marker as a function of the rotation about the axis of the zone of the tool.

19. The method according to claim 12, further comprising:
adding an accessory in the zone of the tool,
placing a zone of the accessory on the fixed point for which the location is known,
determining, by the image-capturing device, the position of the visual marker relative to the image-capturing device,
determining the position of said zone of the accessory relative to the image-capturing device, based on the position of the visual marker relative to the image-capturing device and based on the location of the fixed point relative to the calibration device,
determining an axis of the zone of the tool relative to the image-capturing device, based on the position of said zone of the tool relative to the image-capturing device and based on the position of said zone of the accessory relative to the image-capturing device.

20. The method according to claim 19, further comprising, in order to detect a change of a second accessory attached to the zone of the tool,
determining, by the image-capturing device, the position of one end of the second accessory relative to the image-capturing device, based on the axis of the zone of the tool.

21. A computer program comprising instructions for implementing the method according to claim 12 when this program is executed by a processor.

22. A non-transitory computer-readable storage medium on which is stored a program for implementing the method according to claim 12 when this program is executed by a processor.
